(19) United States
(12) Patent Application Publication
(10) Pub. No.: US 2003/0150728 A1
(43) Pub. Date: Aug. 14, 2003

(54) Method and device for separating marked biopolymers

(76) Inventor: Rudolf Rigler, St Sulpice (CH)

Correspondence Address: FULBRIGHT & JAWORSKI, LLP, 666 FIFTH AVE, NEW YORK, NY, 10103-3198, US

(21) Appl. No.: 10/276,037

(22) PCT Filed: May 11, 2001
(86) PCT No.: PCT/EP01/05409

(30) Foreign Application Priority Data
May 12, 2000 (DE) 10023422.4

(51) Int. Cl. G01N 27/26; G01N 27/453; G01N 27/403

(52) U.S. Cl. 204/455; 204/461; 204/605; 204/612

(57) ABSTRACT

The invention relates to a method and a device for detecting marked biopolymers, especially nucleic acid fragments in a gel matrix. A parallel separation takes place in a number of microcapillaries that are filled with a gel matrix.

### DESCRIPTION

The invention relates to a method and an apparatus for detecting labeled biopolymers, in particular nucleic acid fragments, in a gel matrix, with parallel fractionation being carried out in a multiplicity of microcapillaries filled with a gel matrix.

Two methods for DNA sequencing are generally known, namely the chemical degradation method according to Maxam and Gilbert (Proc. Natl. Acad. Sci. USA 74 (1977), 560; Meth. Enzymol. 65 (1980), 499) and the enzymatic chain termination method according to Sanger et al. Proc. Natl. Acad. Sci. USA 74 (1977), 5463).

In the Maxam-Gilbert method labeled DNA molecules are chemically modified in a base-specific manner, partial strand termination is effected, the fragments obtained in this way are size-fractionated and the sequence is determined on the basis of said labeling.

In the method according to Sanger, starting from a DNA template, a multiplicity of labeled nucleic acid fragments of different lengths are prepared by enzymatic elongation or extension of a synthetic oligonucleotide primer with the aid of polymerase and a mixture of deoxyribonucleoside triphosphates and chain termination molecules, in particular dideoxyribo-nucleoside triphosphates.

The labeled nucleic acid fragments generated according to these and other techniques are usually fractionated via polyacrylamide gel electrophoresis in slab gels or individual capillaries using automatic sequencers. However, this entails the problem that only a limited number of sequencing reactions can be analyzed in parallel.

It was the object of the present invention to provide a method for fractionating labeled biopolymers and, in particular, labeled nucleic acid fragments, which, at least partially, eliminates the disadvantages of the prior art and which makes possible in particular parallel fractionation and detection of a multiplicity of lanes.

This object is achieved by a method for fractionating labeled biopolymers in a gel matrix, said method being characterized in that parallel fractionation is carried out in a multiplicity of microcapillaries filled with a gel matrix.

The method of the invention makes possible the fractionation of labeled biopolymers, for example nucleic acid fragments, in particular DNA or RNA molecules, but also of other biopolymers such as peptides, proteins, saccharides. Particular preference is given to using the method for fractionating nucleic acid fragment mixtures of different lengths, as are produced during a sequencing reaction. Fractionation in the gel matrix is preferably according to size or/and charge of said biopolymers.

Suitable labels of said biopolymers are in particular nonradioactive labeling groups and particularly preferably labeling groups detectable by optical methods, such as, for example, dyes and in particular fluorescent labeling groups. Examples of suitable fluorescent labeling groups are rhodamine, Texas Red, phycoerythrin, fluorescein and other fluorescent dyes common in sequencing.

The labeled biopolymers are fractionated in parallel in a multiplicity of microcapillaries which may be integrated in a compact body, for example a plate or a block. In this connection, preference is given to using at least 10³ microcapillaries and particularly preferably at least 10⁵ microcapillaries, for example about 10⁶ microcapillaries. The diameter of said microcapillaries is preferably essentially identical and may be in the range from preferably 0.5 μm to 10 μm and particularly preferably from 1 μm to 5 μm. Furthermore, said microcapillaries have preferably essentially the same length which may be in the range from 5 mm or longer, preferably from 5 mm to 200 mm and particularly preferably from 5 mm to 100 mm and which is thus considerably shorter than in the case of conventional sequencing gels.

Examples of suitable arrangements which contain a sufficient number of microcapillaries are microchannel plates made of glass, as are employed as photomultipliers in nightsight detectors. These microchannel plates can be filled by capillary forces with a solution forming said gel matrix. The gel can be formed inside the capillaries after filling. A particularly preferred gel matrix is a denaturing polyacrylamide gel, for example a polyacrylamide urea gel.

The biopolymers are fractionated in the micro-capillaries of the gel matrtix by electrophoretic and/or electroosmotic methods, applying, for example, an electric field between the two ends of the microchannel plate. Owing to the short length of the microcapillaries, fractionation in the gel matrix may be, for example, in the range from 10 to 100 V, using a considerably lower voltage than for conventional sequencing gels.

In a preferred embodiment, the fractionation method of the invention is carried out in combination with automatic sample application with positional addressing of the individual samples. For this purpose, it is possible to use, for example, appropriate inkjet or micropipetting apparatuses which are used to apply the mixtures to be fractionated in the particular microcapillaries, for example mixtures from a nucleic acid sequencing reaction, to individual openings of the microchannel plate. Typically, a sample volume of from 10⁻¹² to 10⁻⁶ per microchannel is applied.

The method of the invention furthermore comprises preferably an automatic position-specific detection of the nucleic acid fragments fractionated in the microchannels. This position-specific detection may comprise confocal or/and time-resolved detection. In the case of the preferred fluorescent labeling groups, the fluorescent labels may be excited via an optical dot matrix, for example a dot matrix of laser dots generated by diffraction optics or a quantum well laser. The excited fluorescent groups can be detected by using a confocal detector matrix which may be an arrangement of fiber-coupled avalanche photodiodes or an avalanche photodiode matrix. As an alternative, it is also possible to use an electron detector matrix, for example a CCD camera, which makes time-resolved detection possible. The method of the invention makes possible parallel evaluation of up to more than 10⁶, for example 107, individual channels.

It is possible, for example, to carry out detection according to the method of fluorescence correlation spectroscopy (FCS) described in European patent 0 679 251. This method preferably comprises measuring one or a few sample molecules in a measuring volume, the concentration of the molecules to be determined being <10⁻⁶ mol/l and the measuring volume being preferably <10⁻¹⁴ 1. For details of carrying out the method and details of the apparatuses used for said method, reference is made to the disclosure of European patent 0 679 251.

As an alternative, detection may also be carried out by time-resolved decay measurement, so-called time gating, as described, for example, by Rigler et al: Picosecond Single Photon Fluorescence Spectroscopy of Nucleic Acid, in: “Ultrafast Phenomena”, D. H. Auston, ed. Springer 1984. In this case, the fluorescent molecules are excited in a measuring volume followed by, preferably with a time interval of >100 ps, opening a detection interval on the photodector. In this way it is possible to keep background signals generated by Raman effects sufficiently low in order to enable essentially interference-free detection.

The invention further relates to an apparatus for size fractionation of labeled nucleic acid fragments, comprising

(a) a multiplicity of microcapillaries filled with a gel matrix,

(b) means for automatic sample application into said microcapillaries with positional addressing and

(c) means for automatic position-specific detection of nucleic acids in said microcapillaries.

The apparatus may furthermore comprise automatic manipulation devices for positioning microchannel plates in automatic sequencers, heating or cooling equipment such as Peltier elements in order to keep the temperature essentially constant, reservoirs and, where appropriate, supply lines for sample fluids and reagents and also electronic evaluation devices.

The method of the invention and the apparatus of the invention may be used for all electrophoretic and electroosmotic methods, for example for fractionating products of a nucleic acid sequencing reaction, for analyzing protein fragments or for genome, transcriptome or proteome analysis.

Furthermore, the present invention is intended to be illustrated by the following figures and examples in which:

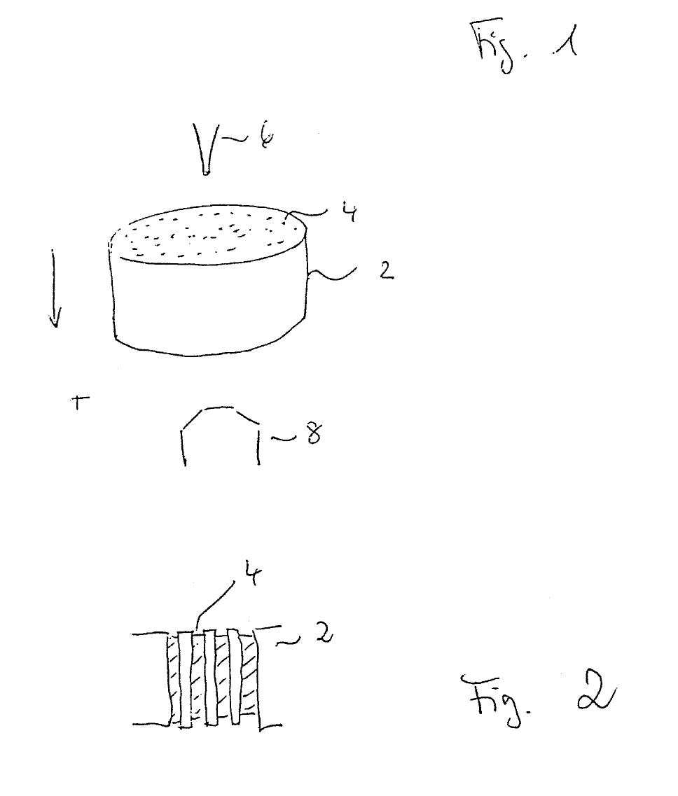

FIG. 1 shows the diagrammatic representation of an apparatus suitable for carrying out the method of the invention. The apparatus contains a microchannel plate (2) with about 10⁶ microchannels (4) for fractionating nucleic acid fragments. The apparatus furthermore contains an inkjet apparatus (6) for automatic sample application into individual microcapillaries with positional addressing and an automatic position-specific detector (8) which can be used to detect labeled nucleic acids which have migrated through said microcapillaries. The nucleic acids migrate in an electric field (from minus to plus).

FIG. 2 shows a cross section through a microchannel plate. The microchannels (4) are filled with a gel matrix, for example a polyacrylamide/6 M urea gel.

1. A method for fractionating labeled biopolymers in a gel matrix, characterized in that parallel fractionation is carried out in a multiplicity of microcapillaries filled with a gel matrix.

2. The method as claimed in claim 1, characterized in that the biopolymers are selected from the group consisting of nucleic acids, peptides, proteins and saccharides.

3. The method as claimed in claim 2, characterized in that nucleic acid fragments are fractionated.

4. The method as claimed in any of claims 1 to 3, characterized in that the biopolymers carry a fluorescent label.

5. The method as claimed in any of claims 1 to 4, characterized in that parallel fractionation is carried out in at least 10³ microcapillaries.

6. The method as claimed in claim 5, characterized in that parallel fractionation is carried out in at least 10⁵ microcapillaries.

7. The method as claimed in any of claims 1 to 6, characterized in that the microcapillaries have a diameter in the range from 1 μm to 5 μm.

8. The method as claimed in any of claims 1 to 7, characterized in that the microcapillaries have a length in the range from 5 mm to 200 mm.

9. The method as claimed in any of claims 1 to 8, characterized in that an electrophoretic and/or electroosmotic fractionation is carried out.

10. The method as claimed in any of claims 1 to 9, characterized in that an automatic sample application with positional addressing is carried out.

11. The method as claimed in claim 10, characterized in that the sample is applied by an inkjet apparatus.

12. The method as claimed in any of claims 1 to 10, characterized in that an automatic position-specific detection is carried out.

13. The method as claimed in claim 12, characterized in that a confocal or/and time-resolved detection is carried out.

14. The method as claimed in claim 12 or 13, characterized in that detection is carried out by exciting the fluorescent labels via an optical dot matrix and a detector matrix.

15. An apparatus for size fractionation of labeled nucleic acid fragments, comprising
(a) a multiplicity of microcapillaries filled with a gel matrix,
(b) means for automatic sample application into said microcapillaries with positional addressing and
(c) means for automatic position-specific detection of labels in said microcapillaries.

16. The use of the apparatus as claimed in claim 15 for carrying out the method as claimed in any of claims 1 to 14.
